(19) United States
(12) Patent Application Publication
(10) Pub. No.: US 2020/0351452 A1
(43) Pub. Date: Nov. 5, 2020

(54) VISUALIZATION OF AUDIO SIGNALS FOR SURVEILLANCE

(71) Applicant: Xinova, LLC, Seattle, WA (US)

(72) Inventor: Yang-Won JUNG, Seoul (KR)

(73) Assignee: Xinova, LLC, Seattle, WA (US)

(21) Appl. No.: 16/957,170

(22) PCT Filed: Jan. 4, 2018
(86) PCT No.: PCT/US18/12339

§ 371 Date: Jun. 23, 2020

(51) Int. Cl. H04N 5/272; G10L 21/10; H04R 1/40; H04R 3/00; G10L 25/57; H04N 7/18; G10L 15/22; H04R 1/08

(52) U.S. Cl. CPC H04N 5/272; G10L 21/10; H04R 1/406; H04R 3/005; H04R 2499/11; H04N 7/183; G10L 15/22; H04R 1/08; G10L 25/57

(57) ABSTRACT

Technologies are described for visualization of an audio signal with a corresponding video signal for surveillance. An audio capture device may be configured in a surveillance area to capture an audio signal. One or more image capture devices may be configured to capture a video signal in the surveillance area. The audio capture device and the image capture device may be integrated into a capture device in some examples. The audio capture device and the image capture device may be configured to transmit the audio signal and the video signal to a signal processor, which may be configured to match the audio signal with a corresponding video signal, analyze the audio signal to extract information associated with surveillance, and overlay the corresponding video signal with the extracted information from the audio signal.

### BACKGROUND

Unless otherwise indicated herein, the materials described in this section are not prior art to the claims in this application and are not admitted to be prior art by inclusion in this section.

A large number of cameras may be installed at various locations to monitor activity within a surveillance area. The video signals from these cameras may be transmitted back to a surveillance control room. In the control room, there may be a large number (e.g., tens or hundreds) of videos displayed simultaneously to be monitored by security personnel. Audio signals may also be captured within the surveillance areas and the security personnel may manually select one or more audio signals to listen to in order to gather more information associated with surveillance. The number of audio and video sources may result in an inefficient surveillance system.

### SUMMARY

The present disclosure generally describes techniques for visualization of an audio signal with a corresponding video signal for surveillance.

According to some examples a method to visualize an audio signal for a surveillance may comprise receiving the audio signal captured by an audio capture device, receiving one or more video signals captured by an image capture device, analyzing the audio signal to extract information associated with the surveillance, matching the audio signal to a corresponding video signal among the one or more video signals, and overlaying a visualization associated with the extracted information on the corresponding video signal.

According to other examples, a server may be configured to visualize an audio signal for a surveillance, the computing device may comprise a communication interface configured to facilitate communication between an audio capture device, an image capture device, and the server, and/or a processor coupled to the communication interface. The processor may be configured to perform or control performance of: receive, from the communication interface, the audio signal captured by the audio capture device, receive, from the communication interface, one or more video signals captured by the image capture device, match the audio signal to a corresponding video signal among the one or more video signals based on a spatial relationship between the audio capture device and the image capture device. The processor may be further configured to perform or control performance of: analyze the audio signal to extract information associated with the surveillance and overlay a visualization associated with the extracted information on the corresponding video signal. The information associated with the surveillance may include one or more of a type of sound in the audio signal, a common spoken word in the audio signal, a direction of sound in the audio signal, and a level of sound in the audio signal.

According to further examples a system may be configured to visualize an audio signal for a surveillance. The system may comprise an audio capture device, an image capture device, a display device, a server, and/or a communication interface. The communication interface may be configured to facilitate communication between the audio capture device, the image capture device, the display device, and the server. The audio capture device may be configured to capture the audio signal, and the image capture device may be configured to capture one or more video signals. The server may comprise a processor configured to receive, from the communication interface, the audio signal from the audio capture device, receive, from the communication interface, the one or more video signals from the image capture device, and match the audio signal to a corresponding video signal among the one or more video signals based on a spatial relationship between the audio capture device and the image capture device. The processor may be further configured to perform or control performance of: analyze the audio signal to extract information associated with the surveillance, overlay a visualization associated with the extracted information on the corresponding video signal, and provide the corresponding video signal with the overlaid visualization of the extracted information to the display device for display. The information associated with the surveillance may include one or more of a type of sound in the audio signal, a common spoken word in the audio signal, a direction of sound in the audio signal, and a level of sound in the audio signal.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIGS. 1A and 1B include conceptual illustrations of example systems configured to visualize an audio signal for surveillance;

FIG. 2 includes a conceptual illustration of an example method to visualize an audio signal when an audio capture device and an image capture device are integrated in a single device;

FIGS. 3A and 3B include conceptual illustrations of example methods to visualize an audio signal when an audio capture device and an image capture device are two separate devices located within a same space;

FIG. 4 illustrates an example scenario when an audio signal may be visualized for surveillance;

FIG. 5 illustrates another example scenario when an audio signal may be visualized for surveillance;

FIG. 6 illustrates a computing device, which may be used to visualize an audio signal for surveillance;

FIG. 7 is a flow diagram illustrating an example method to visualize an audio signal for surveillance that may be performed by a computing device such as the computing device in FIG. 6; and

FIG. 8 illustrates a block diagram of an example computer program product, all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices, and/or computer program products related to visualization of an audio signal with a corresponding video signal for surveillance.

Briefly stated, technologies are generally described to visualize an audio signal with a corresponding video signal for surveillance. An audio capture device may be configured in a surveillance area to capture an audio signal. One or more image capture devices may be configured to capture a video signal in the surveillance area. The audio capture device and the image capture device may be integrated into a capture device in some examples. The audio capture device and the image capture device may be configured to transmit the audio signal and the video signal to a signal processor, which may be configured to match the audio signal with a corresponding video signal, analyze the audio signal to extract information associated with surveillance, and overlay the corresponding video signal with the extracted information from the audio signal.

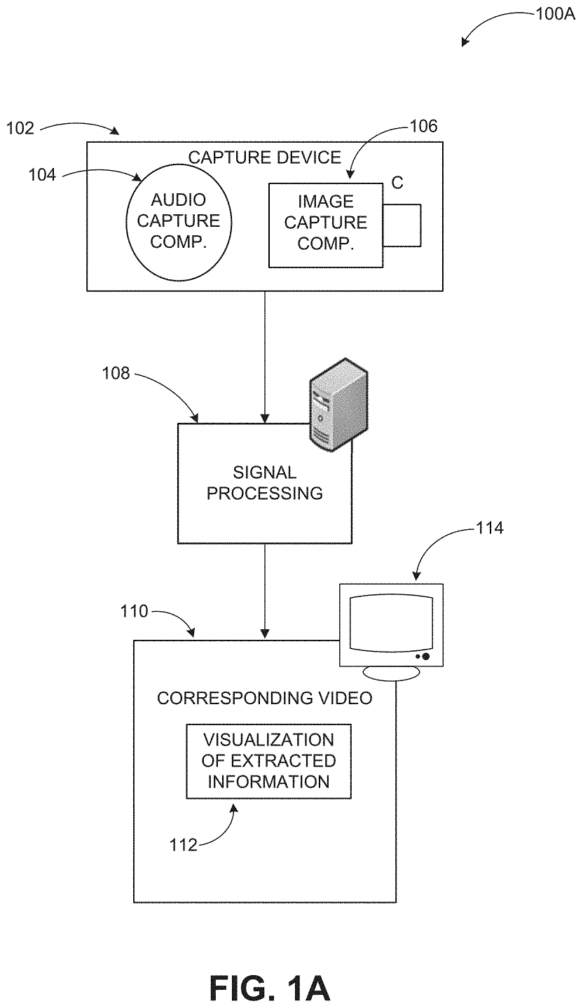

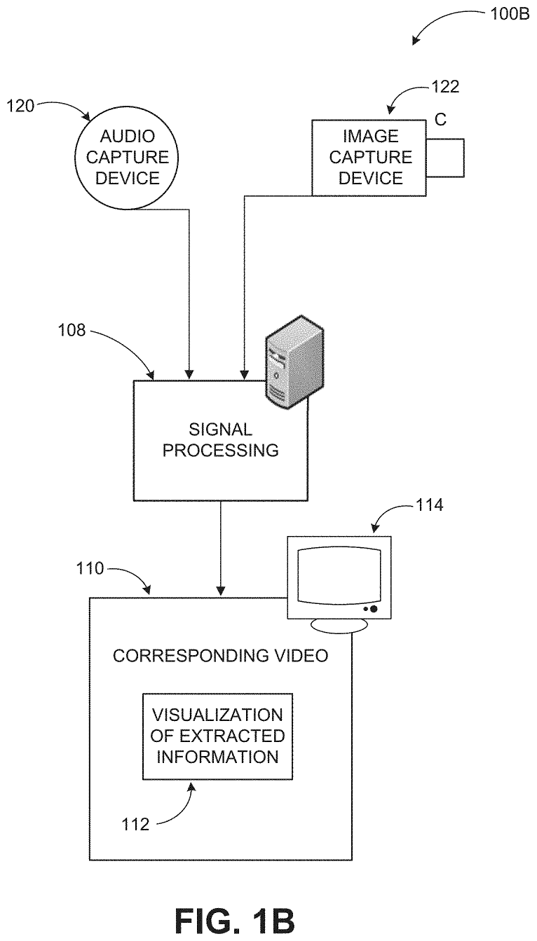

FIGS. 1A and 1B include conceptual illustrations of example systems configured to visualize an audio signal for surveillance, arranged in accordance with at least some embodiments described herein.

As shown in diagram 100A of FIG. 1A, a capture device 102 may be configured to capture a first audio signal and a first video signal and to transmit the first audio signal and the first video signal to a signal processor 108. The capture device 102 may be positioned in a particular location to capture audio signals and video signals associated with surveillance of an area and may be one of a plurality of capture devices within a surveillance system. The capture device 102 may include an audio capture component 104 and an image capture component 106. The audio capture component 104 may include a microphone, and the image capture component 106 may include a camera integrated together in a stationary camera, a mobile camera, a body-mounted camera, or a camera of a smartphone, for example.

The signal processor 108 may include a computing device (e.g., a server, a desktop computer, a mobile computer, a special purpose computing device, or a component level processor) and may receive the first audio signal and the first video signal from the capture device 102. The signal processor 108 may also match the audio signal with the first video signal sent from the capture device 102 and analyze the audio signal to extract information associated with surveillance. Information associated with surveillance may include a type of sound in the audio signal, a common spoken word in the audio signal, a direction of sound in the audio signal, or a level of sound in the audio signal, for example. In an example scenario, the signal processor 108 may determine that the audio capture component 104 and the image capture component 106 are integrated and match the audio signal and the video signal accordingly.

In some examples, the signal processor 108 may overlay a visualization associated with the extracted information on the corresponding video signal. The signal processor 108 may provide the video signal to be displayed with the visualization of the extracted information 112 on a display device 114. The display device 114 may include a television, a computing device, a monitor, a projection screen, a mobile device, among other things. In some examples, the visualization of the extracted information 112 may include a variety of textual, graphical, coloring, highlighting, shading, and/or animation schemes.

The signal processor 108 may also determine a type of sound in the audio signal, a common spoken word in the audio signal, a direction of sound in the audio signal, and/or a level of sound in the audio signal as the information associated with the surveillance. In further examples, the signal processor 108 may perform classification techniques, speech recognition techniques, or may filter the extracted information for critical surveillance information. The signal processor 108 may filter the extracted information based on the type of sound and the common spoken word in order to prioritize visualization of critical information from the audio signal.

In some examples, the signal processor 108 may receive a second audio signal captured by another audio capture device and match both the first audio signal and the second audio signal to the first video signal. The signal processor 108 may correlate a type of sound within the first audio signal with a similar type of sound within the second audio signal to determine the direction of sound. In further examples, the signal processor 108 may analyze a level and/or other characteristics (e.g., frequency) of sound of the first audio signal with a level of sound of the second audio signal to determine the direction of sound. In an example scenario, the first audio signal may include a gunshot sound. The sound level of the gun shot may be loud, but no other sound may be included in the first audio signal. In the meantime, the second audio signal may include a quieter gunshot sound, but louder background noise. Through analysis of not only the levels, but other sound characteristics such as frequency, a system according to embodiments may distinguish the gunshot sounds. For example, the gunshot sounds may be extracted from the first and second audio signals and the levels of the extracted gunshot sounds in each audio signal may be compared to track the direction of the gunshot sound. The signal processor 108 may also determine if a resource should be deployed based on the level of or a change in the level of sound in an audio signal. The resource may include security personnel or local law enforcement among other options.

In alternate embodiments, such as those shown in diagram 100B of FIG. 1B, an audio capture device 120 may be configured to capture an audio signal and to send the audio signal to the signal processor 108. The audio capture device 120 may include a microphone, a component integrated with a communication device, or a component integrated with a mobile device positioned in a particular location to capture audio signals associated with surveillance. An image capture device 122 may separately capture a video signal and send the video signal to the signal processor 108. The image capture device 122 may include a stationary camera, a mobile camera, such as a camera mounted on a drone, a body-mounted camera, a camera integrated into a mobile device, a thermal camera, for example. The image capture device 122 may be positioned in a particular location to capture video signals associated with surveillance. The audio capture device 120 and the image capture device 122 may each be one of a plurality of capture devices within a surveillance system.

The signal processor 108 may determine a spatial relationship between the audio capture device 120 and the image capture component 106 by determining a location of the audio capture device 120 and an orientation of the image capture device 122, for example. In some examples, the signal processor 108 may match the audio signal to the corresponding video signal based on the determined spatial relationship. The signal processor 108 may analyze the audio signal to extract information associated with surveillance and to overlay a visualization associated with the extracted information on the corresponding video signal. The signal processor 108 may then provide the video signal to be displayed with the visualization of the extracted information 112 on a display device 114.

In an example scenario, a microphone may be positioned to capture an audio signal in a hallway for surveillance purposes and may send the audio signal to a signal processor. Additionally, a camera may be positioned near the microphone in the hallway to capture a video signal for surveillance purposes and may send the video signal to the signal processor. The signal processor may match the audio signal from the microphone and the video signal from the camera based on their proximity. The signal processor may then analyze the audio signal to extract information associated with surveillance, such as an average sound level of the hallway, among other things. The signal processor may then overlay a visualization indicating the average sound level of the hallway on the video signal from the camera. The signal processor may then provide the video signal with the visualization overlaid to be displayed on a monitor in a surveillance control room.

In the conceptual diagrams 100A and 100B, the positioning and structure of the capture device 102, the audio capture component 104, the image capture component 106, the audio capture device 120, the image capture device 122, the signal processor 108, the corresponding video 110, the visualization of extracted information 112, and the display device 114 have been simplified for clarity. Configurations of the capture device 102, the audio capture component 104, the image capture component 106, the audio capture device 120, the image capture device 122, the signal processor 108, the corresponding video 110, the visualization of extracted information 112, and the display device 114 are not limited to the configurations illustrated in the diagrams 100A and 100B.

In typical surveillance systems, a large number of cameras may be installed at various locations to monitor activity within surveillance areas. Audio signals may also be captured by audio capture devices within the surveillance areas as well. The video signals from the cameras may be transmitted back to a surveillance control room. In the control room, there may be tens or hundreds of videos displayed simultaneously to be monitored by security personnel. In order to gather more information associated with surveillance, the security personnel may manually select one or more audio signals to listen to. However, it may be difficult for the security personnel to monitor more than one audio signal at a time. This may lead to the security personnel not gathering information found in the audio signal but not the video signals, such as cries for help among other things. By overlaying the video signals with visualizations of information associated with surveillance extracted from a corresponding audio signal, the security personnel may be enabled to parse surveillance related information faster, more efficiently and more reliably to ensure the safety of the people in the surveillance area.

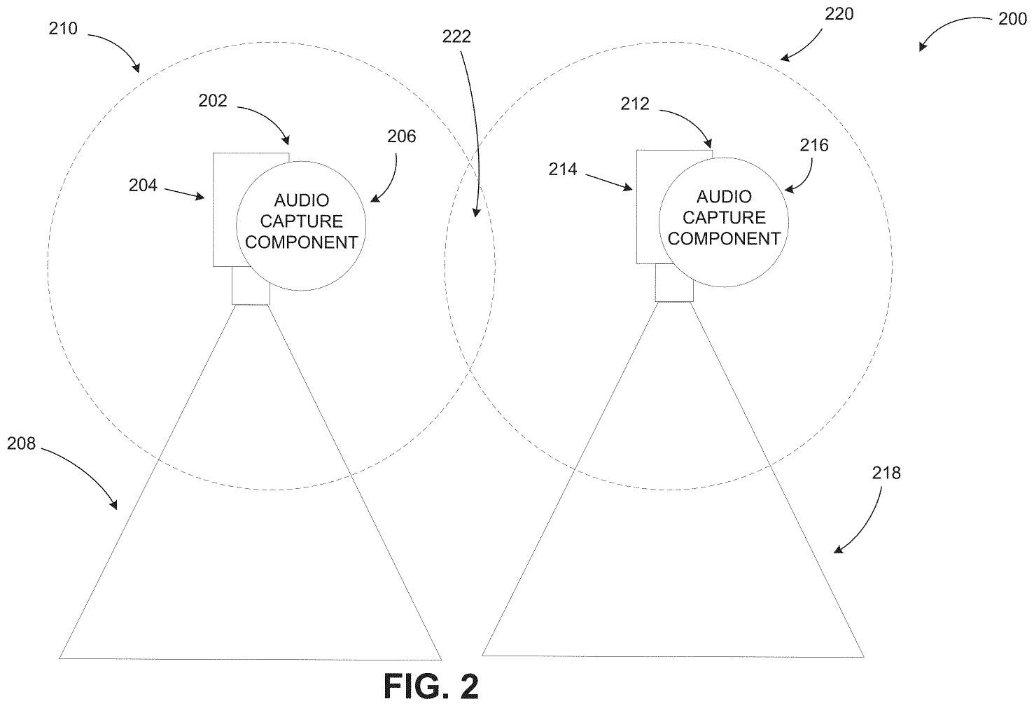

FIG. 2 includes a conceptual illustration of an example method to visualize an audio signal when an audio capture device and an image capture device are integrated in a single device, arranged in accordance with at least some embodiments described herein.

As shown in diagram 200, a first capture device 202 may be configured to capture a first audio signal and a first video signal. The first capture device 202 may include an image capture component 204 and an audio capture component 206. The image capture component 204 may include a camera oriented to capture the video signal from a field of view 208. The audio capture component 206 may include a microphone positioned to capture the audio signal from a surveillance area 210. The first capture device 202 may send the first audio signal and the first video signal to a signal processor. The signal processor may match the first audio signal and the first video signal and may analyze the first audio signal to extract surveillance information, such as an average sound level for example. The signal processor may match the audio signal based on a determination that the audio capture component 206 and the image capture component 204 are integrated in the first capture device 202. The signal processor may overlay the first video signal from the field of view 208 with a visualization of the extracted information from the surveillance area 210.

In further examples, a second capture device 212 may be positioned to capture a second audio signal and a second video signal. The second capture device 212 may include an image capture component 214 and an audio capture component 216. The image capture component 214 may include a camera oriented to capture the second video signal from a field of view 218. The audio capture component 216 may include a microphone positioned to capture the second audio signal from a surveillance area 220. The surveillance area 220 may overlap with the surveillance area 210 which may result in the audio capture component 216 and the audio capture component 206 capturing an audio signal from an overlapping surveillance area 222. The second capture device 212 may send the second audio signal and the second video signal to the signal processor. The signal processor may match the second audio signal and the second video signal, analyze the second audio signal to extract surveillance information, and overlay the second video signal with a visualization of the extracted information from the surveillance area 220.

In other examples, the signal processor may match the second audio signal with the first video signal in response to detecting a sound from the overlapping surveillance area 222. The signal processor may determine a direction of sound based on a location of the audio capture component 206 and the location of the audio capture component 216. In further examples, the signal processor may correlate a type of sound within the first audio signal with a type of sound within the second audio signal to determine the direction of sound. The signal processor may also compare a level of sound of the first audio signal with a level of sound of the second audio signal to determine the direction of sound.

In the same example as discussed above in conjunction with FIGS. 1A and 1B, a second camera with an integrated microphone may be positioned in the same hallway to capture a second audio signal and a second video signal for surveillance purposes. The surveillance zones monitored by the microphone and the camera-integrated microphone may overlap. If a gunshot or another surveillance-related sound occurred in the overlapping surveillance zone, the signal processor may utilize the first audio signal from the microphone and the second audio signal from the camera-integrated microphone to determine a direction of sound. The signal processor may then overlay a corresponding video signal with a visualization indicating a gunshot had occurred and may provide the corresponding video signal with the visualization to be displayed on a monitor in the security headquarters. The visualization may also include information indicating the direction the gunshot originated from.

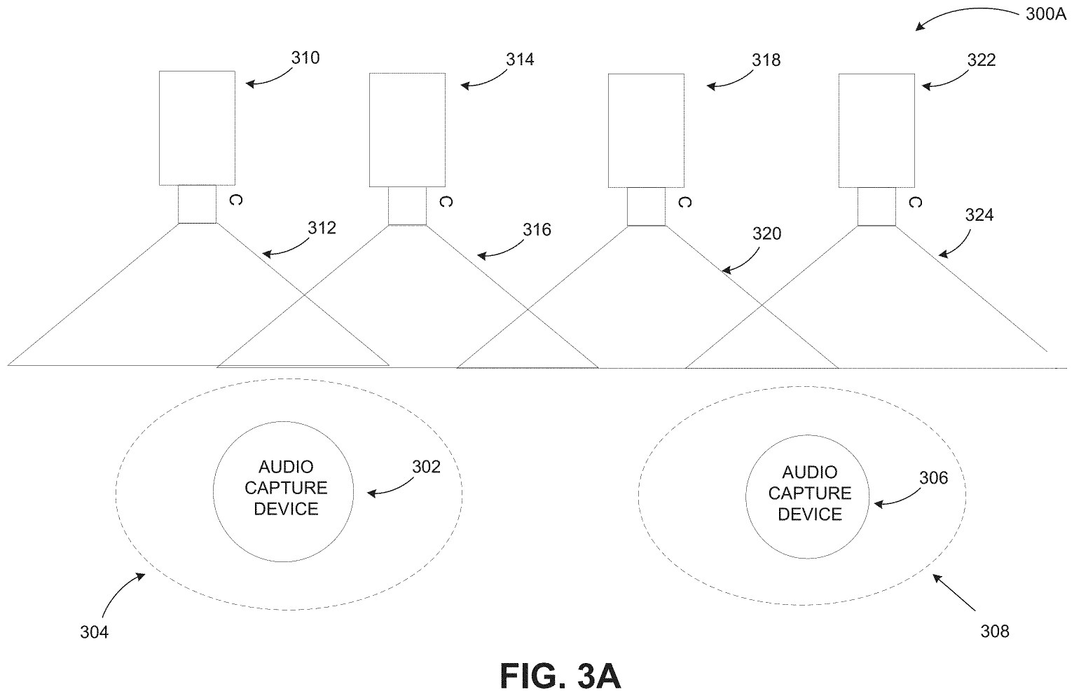

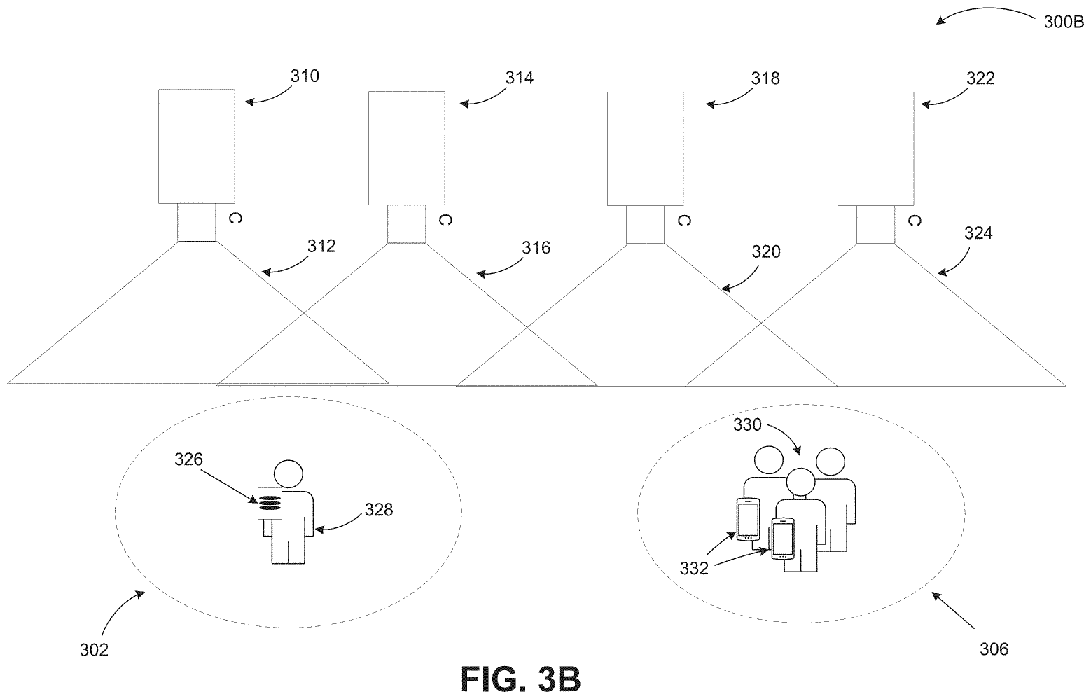

FIGS. 3A and 3B include conceptual illustrations of example methods to visualize an audio signal when an audio capture device and an image capture device are two separate devices located within a same space arranged in accordance with at least some embodiments described herein.

As shown in diagram 300A of FIG. 3A, a first audio capture device 302 may be positioned to capture a first audio signal from a first surveillance zone 304, and a second audio capture device 306 may be positioned to capture a second audio signal from a second surveillance zone 308, for example. The first audio capture device 302 and the second audio capture device 306 may transmit the first audio signal and the second audio signal to a signal processor. A plurality of image capture devices, 310, 314, 318, and 322, may be oriented to capture a video signal from a field of view, 312, 316, 320, and 324 respectively, and may send a video signal to the signal processor.

In some examples, the signal processor may match the first audio signal with a corresponding video signal by determining spatial relationships between the audio capture device 302 and the image capture devices 310 and 314. The spatial relationships may be based on the location of the audio capture device 302 and the orientation of the image capture devices 310 and 314, for example. The signal processor may analyze the first audio signal to extract information associated with surveillance and may overlay the corresponding video signal with the extracted information from the first audio signal. In some examples, the signal processor may also provide the corresponding video signal with the extracted information overlaid to be displayed on a display device.

As shown in diagram 300B of FIG. 3B, a communication device 326 may have an integrated audio capture device that may capture a first audio signal from the surveillance area304. The communication device 326 may be utilized by a security guard 328 to communicate with other security personnel. One or more mobile devices 332 associated with the citizens 330 may have integrated audio capture devices that may capture a second audio signal from the surveillance area 308. The communication device 326 and the one or more mobile devices 332 may transmit the captured audio signals to the signal processor. The signal processor may match the second audio signal with a corresponding video signal, analyze the audio signal to extract surveillance information, and overlay the corresponding video signal with the extracted information.

In the same example as discussed above in conjunction with FIGS. 1A, 1B, and 2, a security guard with a walkie-talkie may be patrolling the hallway at the time of the gunshot. The walkie-talkie may be configured to capture a third audio signal and to transmit the third audio signal to the signal processor. The signal processor may match the third audio signal from the walkie-talkie to a corresponding video signal from the first camera or second camera, analyze the third audio signal to extract surveillance associated information, e.g., the gunshot, and overlay the corresponding video signal with the extracted information. The signal processor may also utilize the third audio signal to determine a direction of sound using the above-discussed methods.

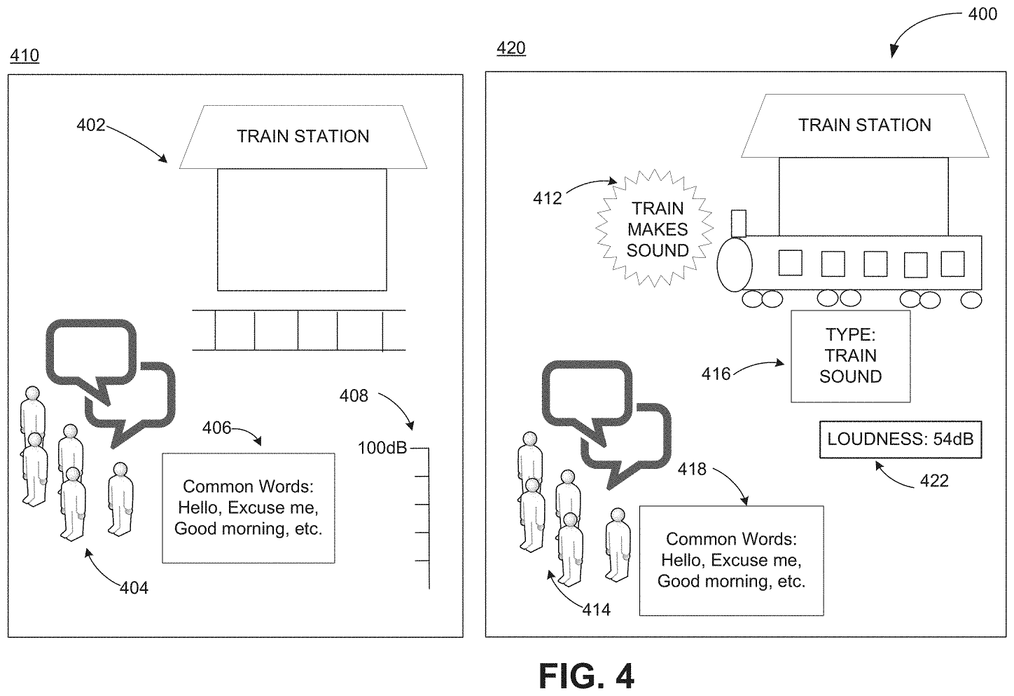

FIG. 4 illustrates an example scenario when an audio signal may be visualized for surveillance arranged in accordance with at least some embodiments described herein.

As shown in diagram 400, a display device 410 may display a video signal and one or more visualizations of information associated with surveillance. The display device 410 may include a television, a wall-mount display, a monitor, a projection screen, a mobile device, for example. The visualizations of information associated with surveillance may be overlaid on the video signal by a signal processor prior to being displayed on the display device 410. The visualizations may implement a variety of textual, graphical, coloring, highlighting, shading, or animation schemes. The video signal being displayed on the display device 410 may include a train station 402 and a crowd of people 404 conversing amongst themselves. The video signal may also include an overlaid visualization 406 that indicates common words being said in the area extracted from the corresponding audio signal and an overlaid meter 408 to indicate the average sound level in the area, for example.

A second display device 420 may also display a video signal and one or more visualizations of information associated with surveillance. The video signal being displayed on the display device 420 may include a train making noises at a train station 412 and a crowd of people 414 conversing amongst themselves. The video signal being displayed on the display device 420 may include an overlaid visualization of the sounds associated with the train 416 and an overlaid visualization that indicates common words being said in the area 418. The video signal being displayed on the display device 420 may also include text indicating the average sound level in the area 422 instead of a meter similar to overlaid meter 408, for example.

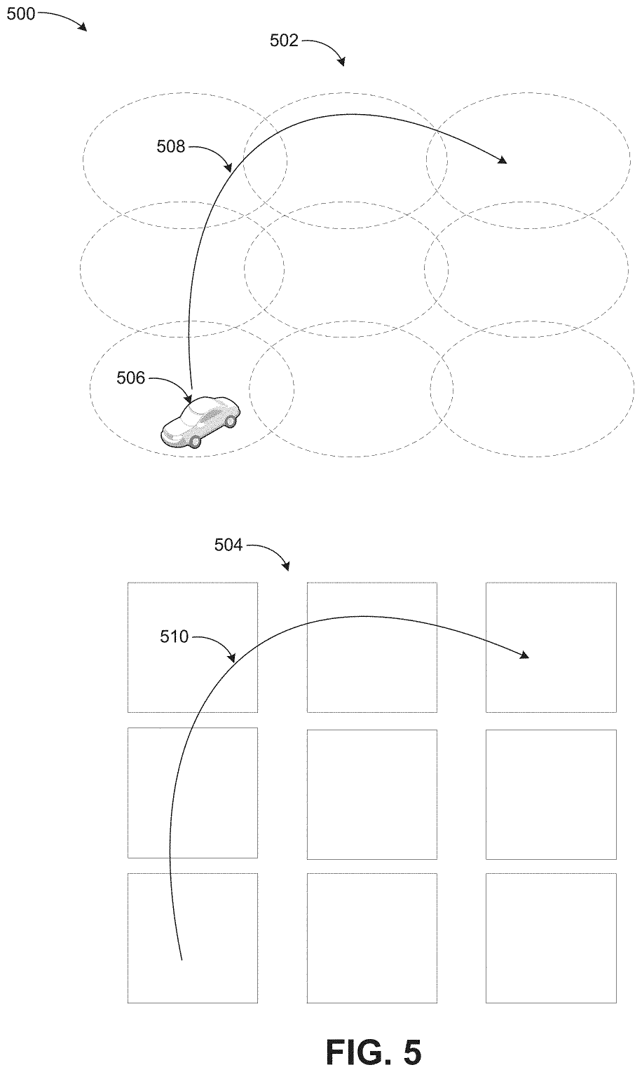

FIG. 5 illustrates another example scenario when an audio signal may be visualized for surveillance.

As shown in diagram 500, a group of surveillance areas 502 may be monitored by a plurality of audio capture devices. The audio capture devices may capture and transmit respective audio signals to a signal processor. The group of surveillance areas 502 may also be monitored by a plurality of image capture devices. The image capture devices may capture respective video signals and transmit the video signals to a signal processor. The signal processor may match audio signals with corresponding video signals, analyze the audio signals to extract information associated with surveillance, and overlay the video signals with the extracted information from the corresponding audio signals. The signal processor may then provide the video signals to be displayed with the extracted information overlaid on a group of display devices 504.

In the example scenario shown in diagram 500, a car 506 may travel through the group of surveillance areas 502 along the path 508. The audio capture devices may capture an audio signal that includes sounds associated with the car 506 as it travels along the path 508. The signal processor may then overlay a visualization associated with the sounds made by the car 506 on a corresponding video signal. The visualizations may include “Car Idling” if the car 506 is stopped at a stop sign in one of the surveillance areas or “Car Accelerating” if the car 506 speeds away suddenly, for example. The signal processor may provide the corresponding video signal to be displayed with the overlaid surveillance information to be displayed on a corresponding display device from the group of display devices 504. As the car 506 traverses the path 508, the signal processor may transfer the visualization associated with the sounds made by the car to subsequent video signals that correspond captured audio signals from surveillance areas along the path 508. In this example, the visualization associated with the sounds made by the car may be transferred between the video signals shown the display devices along the arrow 510.

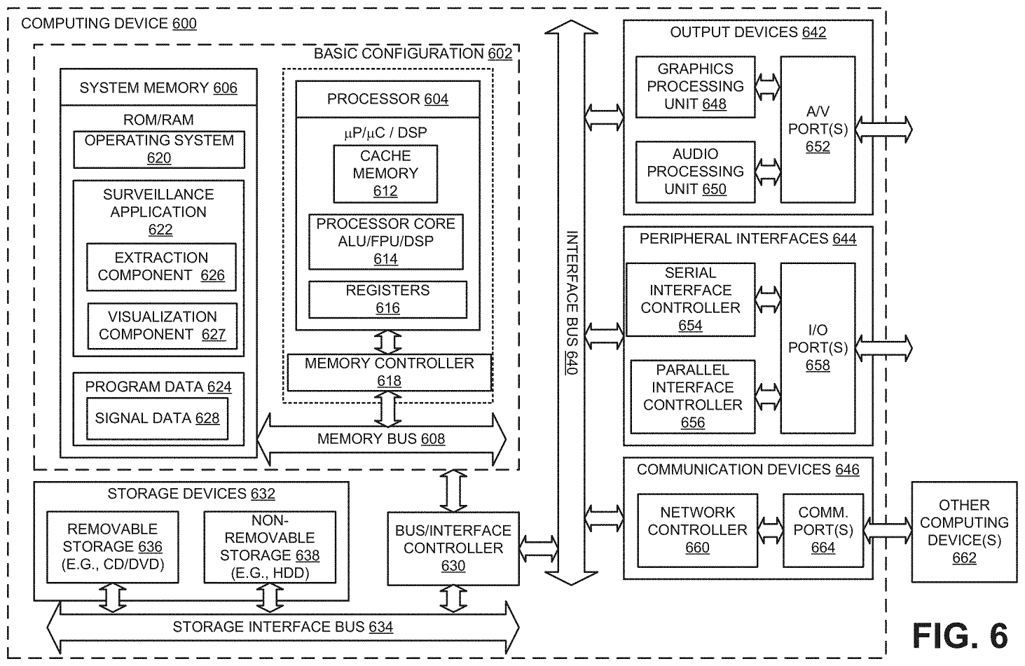

FIG. 6 illustrates a computing device, which may be used to visualize an audio signal for surveillance arranged in accordance with at least some embodiments described herein.

In an example basic configuration 602, the computing device 600 may include one or more processors 604 and a system memory 606. A memory bus 608 may be used to communicate between the processor 604 and the system memory 606. The basic configuration 602 is illustrated in FIG. 6 by those components within the inner dashed line.

Depending on the desired configuration, the processor 604 may be of any type, including but not limited to a microprocessor (μP), a microcontroller (μC), a digital signal processor (DSP), or any combination thereof. The processor 604 may include one or more levels of caching, such as a cache memory 612, a processor core 614, and registers 616. The example processor core 614 may include an arithmetic logic unit (ALU), a floating point unit (FPU), a digital signal processing core (DSP core), or any combination thereof. An example memory controller 618 may also be used with the processor 604, or in some implementations, the memory controller 618 may be an internal part of the processor 604.

Depending on the desired configuration, the system memory 606 may be of any type including but not limited to volatile memory (such as RAM), non-volatile memory (such as ROM, flash memory, etc.) or any combination thereof. The system memory 606 may include an operating system 620, a surveillance application 622, and program data 624. The surveillance application 622 may include an extraction component 626 and a visualization component 627. The surveillance application 622 may be configured to send and/or receive audio and video signals associated with surveillance. The extraction component 626 may be configured to analyze an audio signal to extract information associated with surveillance. Information associated with surveillance may include a type of sound in the audio signal, a common spoken word in the audio signal, a direction of sound in the audio signal, or a level of sound in the audio signal among other things. The visualization component 627 may be configured to overlay a visualization associated with the extracted information on the corresponding video signal. The visualization may include one or more of textual, graphical, coloring, highlighting, shading, or animation schemes. The program data 624 may include, among other data, signal data 628 or the like, as described herein.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices include magnetic disk devices such as flexible disk drives and hard-disk drives (HDDs), optical disk drives such as compact disc (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVDs), solid state drives (SSDs), or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (e.g., one or more output devices 642, one or more peripheral interfaces 644, and one or more communication devices 646) to the basic configuration 602 via the bus/interface controller 630. Some of the example output devices 642 include a graphics processing unit 648 and an audio processing unit 650, which may be configured to communicate to various external devices such as a display or speakers via one or more A/V ports 652. One or more example peripheral interfaces 644 may include a serial interface controller 654 or a parallel interface controller 656, which may be configured to communicate with external devices such as input devices (e.g., keyboard, mouse, pen, voice input device, touch input device, etc.) or other peripheral devices (e.g., printer, scanner, etc.) via one or more I/O ports 658. An example communication device 646 includes a network controller 660, which may be arranged to facilitate communications with one or more other computing devices 662 over a network communication link via one or more communication ports 664. The one or more other computing devices 662 may include servers at a datacenter, customer equipment, and comparable devices.

The network communication link may be one example of a communication media. Communication media may be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a part of a general purpose or specialized server, mainframe, or similar computer that includes any of the above functions. The computing device 600 may also be implemented as a personal computer including both laptop computer and non-laptop computer configurations.

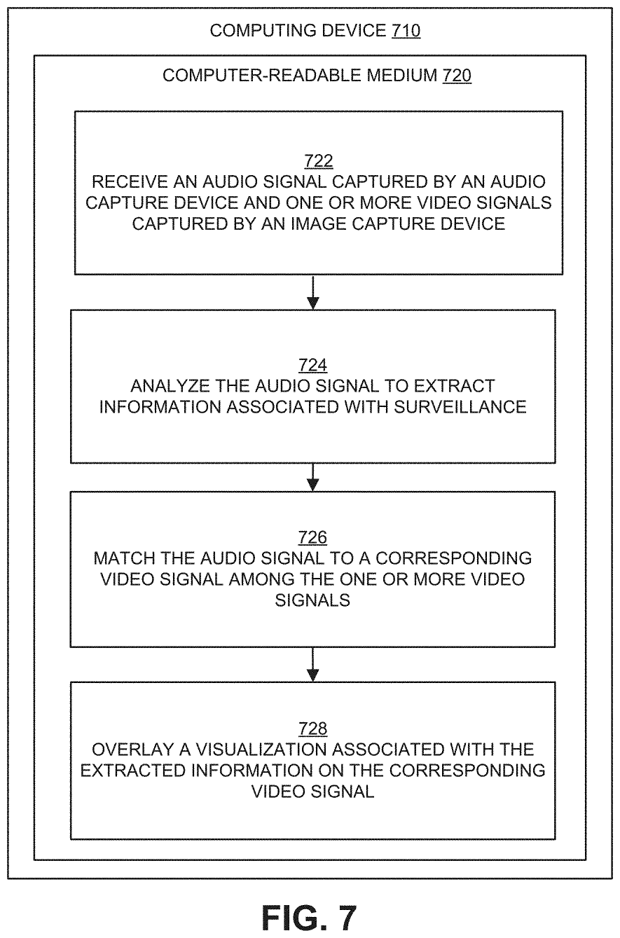

FIG. 7 is a flow diagram illustrating an example method to visualize an audio signal with a corresponding video signal for surveillance that may be performed by a computing device such as the computing device in FIG. 6.

Example methods may include one or more operations, functions, or actions as illustrated by one or more of blocks 722, 724, 726, and/or 728, and may in some embodiments be performed by a computing device such as the computing device 710 in FIG. 7. Such operations, functions, or actions in FIG. 7 and in the other figures, in some embodiments, may be combined, eliminated, modified, and/or supplemented with other operations, functions, or actions, and need not necessarily be performed in the exact sequence as shown. The operations described in the blocks 722-728 may also be implemented through execution of computer-executable instructions stored in a computer-readable medium such as a computer-readable medium 720 of a computing device 710.

An example process to visualize an audio signal with a corresponding video signal for surveillance may begin with block 722, “RECEIVE AN AUDIO SIGNAL CAPTURED BY AN AUDIO CAPTURE DEVICE AND ONE OR MORE VIDEO SIGNALS CAPTURED BY AN IMAGE CAPTURE DEVICE”, where an audio signal captured by an audio capture device within a surveillance area and one or more video signals captured by an image captured device within a surveillance area may be received.

Block 722 may be followed by block 724, “ANALYZE THE AUDIO SIGNAL TO EXTRACT INFORMATION ASSOCIATED WITH SURVEILLANCE”, where the audio signal may be analyzed to extract information associated with surveillance. Information associated with surveillance may include a type of sound in the audio signal, a common spoken word in the audio signal, a direction of sound in the audio signal, or a level of sound in the audio signal, for example. Analysis of the audio signal to extract information associated with surveillance may also include classification techniques to determine the type of sound or speech recognition techniques to determine the common spoken word. In some examples, the extracted information may be filtered based on the type of sound and the common spoken word in order to prioritize the extracted information that is visualized.

Block 724 may be followed by block 726, “MATCH THE AUDIO SIGNAL TO A CORRESPONDING VIDEO SIGNAL AMONG THE ONE OR MORE VIDEO SIGNALS”, where the audio signal may be matched with a corresponding video signal. The match may be based on a determination that an audio capture device and an image capture device are integrated, for example. In other examples, a spatial relationship between the audio capture device and the image capture component may be used to match the audio signal to the video signal. The spatial relationship may be based on the location of the audio capture device and the orientation of the image capture device.

Block 726 may be followed by block 728, “OVERLAY A VISUALIZATION ASSOCIATED WITH THE EXTRACTED INFORMATION ON THE CORRESPONDING VIDEO SIGNAL”, where visualizations of information associated with surveillance may be overlaid on the corresponding video signal. The visualizations may include one or more of textual, graphical, coloring, highlighting, shading, or animation schemes, for example.

The operations included in the example process are for illustration purposes. Visualization of audio signals for surveillance may be implemented by similar processes with fewer or additional operations, as well as in different order of operations using the principles described herein. The operations described herein may be executed by one or more processors operated on one or more computing devices, one or more processor cores, specialized processing devices, and/or general purpose processors, among other examples.

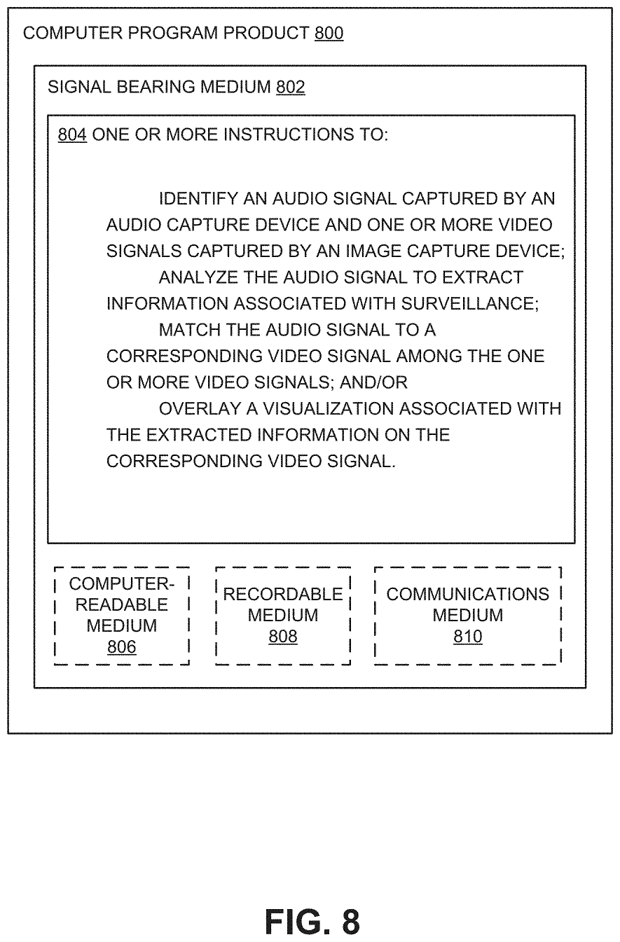

FIG. 8 illustrates a block diagram of an example computer program product, some of which are arranged in accordance with at least some embodiments described herein.

In some examples, as shown in FIG. 8, a computer program product 800 may include a signal bearing medium 802 that may also include one or more machine readable instructions 804 that, in response to execution by, for example, a processor may provide the functionality described herein. Thus, for example, referring to the processor 604 in FIG. 6, the surveillance application 622 may perform or control performance of one or more of the tasks shown in FIG. 8 in response to the instructions 804 conveyed to the processor 604 by the signal bearing medium 802 to perform actions associated with the visualization of audio signals for surveillance as described herein. Some of those instructions may include, for example, instructions to identify an audio signal captured by an audio capture device and one or more video signals captured by an image capture device; match the audio signal to a corresponding video signal among the one or more video signals; analyze the audio signal to extract information associated with surveillance; and overlay a visualization associated with the extracted information on the corresponding video signal, according to some embodiments described herein.

In some implementations, the signal bearing medium 802 depicted in FIG. 8 may encompass computer-readable medium 806, such as, but not limited to, a hard disk drive (HDD), a solid state drive (SSD), a compact disc (CD), a digital versatile disk (DVD), a digital tape, memory, etc. In some implementations, the signal bearing medium 802 may encompass recordable medium 808, such as, but not limited to, memory, read/write (R/W) CDs, R/W DVDs, etc. In some implementations, the signal bearing medium 802 may encompass communications medium 810, such as, but not limited to, a digital and/or an analog communication medium (e.g., a fiber optic cable, a waveguide, a wired communication link, a wireless communication link, etc.). Thus, for example, the computer program product 800 may be conveyed to one or more modules of the processor 604 by an RF signal bearing medium, where the signal bearing medium 802 is conveyed by the communications medium 810 (e.g., a wireless communications medium conforming with the IEEE 802.11 standard).

According to some examples a method to visualize an audio signal for a surveillance may comprise receiving the audio signal captured by an audio capture device, receiving one or more video signals captured by an image capture device, analyzing the audio signal to extract information associated with the surveillance, matching the audio signal to a corresponding video signal among the one or more video signals, and overlaying a visualization associated with the extracted information on the corresponding video signal.

According to other examples, the method may further comprise providing the corresponding video signal with the overlaid visualization of the extracted information to a display device for display and visualizing the extracted information through one or more of textual, graphical, coloring, highlighting, shading, or animation schemes. According to further examples, analyzing the audio signal to extract the information associated with the surveillance may comprise determining one or more of a type of sound in the audio signal, a common spoken word in the audio signal, a direction of sound in the audio signal, and a level of sound in the audio signal as the information associated with the surveillance.

In other examples, determining the type of sound in the audio signal may comprise performing classification techniques to determine the type of sound, performing speech recognition techniques to determine the common spoken word, or filtering the extracted information based on a level of surveillance criticality of the type of sound and the common spoken word in order to prioritize the extracted information that is visualized. According to further examples, determining the direction of sound in the audio signal may comprise receiving another audio signal captured by another audio capture device, wherein the other audio signal includes a same sound as the audio signal, matching the other audio signal to a same corresponding video signal as the audio signal, and determining the direction of sound based on a location of the audio capture device in relation to a location of the other audio capture device. In other examples, determining the direction of sound in the audio signal may comprise receiving another audio signal captured by another audio capture device, matching the other audio signal to a different corresponding video signal than the audio signal, and one or more of correlating a type of sound within the audio signal captured by the audio capture device at a first time with a type of sound within the other audio signal captured by the other audio capture device at a second time to determine the direction of sound or comparing a level of sound of the audio signal captured by the audio capture device at the first time with a level of sound of the other audio signal captured by the other audio capture device at the first time to determine the direction of sound.

According to further examples, matching the audio signal to the corresponding video signal may comprise determining a spatial relationship between the audio capture device and the image capture device. In other examples, determining the spatial relationship may comprise determining that the audio capture device and the image capture device are integrated, and in response to a determination that the audio capture device and the image capture device are not integrated: determining a location of the audio capture device, determining an orientation of the image capture device, and matching the audio signal to the corresponding video signal based on the location of the audio capture device and the orientation of the image capture device. According to further examples, the audio capture device may be located in a same space as the image capture device, may be one of: integrated with the image capture device, integrated with a communication device, integrated with a mobile device, or a separate device, and may include a microphone and the image capture device includes a camera.

According to other embodiments, a server may be configured to visualize an audio signal for a surveillance, the computing device may comprise a communication interface configured to facilitate communication between an audio capture device, an image capture device, and the server, and/or a processor coupled to the communication interface. The processor may be configured to perform or control performance of: receive, from the communication interface, the audio signal captured by the audio capture device, receive, from the communication interface, one or more video signals captured by the image capture device, analyze the audio signal to extract information associated with the surveillance. The processor may be further configured to perform or control performance of: match the audio signal to a corresponding video signal among the one or more video signals based on a spatial relationship between the audio capture device and the image capture device and overlay a visualization associated with the extracted information on the corresponding video signal. The information associated with the surveillance may include one or more of a type of sound in the audio signal, a common spoken word in the audio signal, a direction of sound in the audio signal, and a level of sound in the audio signal.

According to further embodiments, the communication interface may be further configured to facilitate communication between the server and a display device, and the processor may be further configured to perform or control performance of: provide the corresponding video signal with the overlaid visualization of the extracted information to the display device for display. In other embodiments, the corresponding video signal with the overlaid visualization of the extracted information may be displayed through the display device with one or more of textual, graphical, coloring, highlighting, shading, or animation schemes. In further embodiments, the processor may be configured to perform or control performance of: determine whether the audio capture device and the image capture device are integrated to determine the spatial relationship between the audio capture device and the image capture device, and in response to a determination that the audio capture device and the image capture device are not integrated, the processor may be further configured to perform or control performance of: determine a location of the audio capture device, determine an orientation of the image capture device, and match the audio signal to the corresponding video signal based on the location of the audio capture device and the orientation of the image capture device.

In other embodiments, the processor may be further configured to perform or control performance of: determine the type of sound in the audio signal based on classification techniques, determine the common spoken word in the audio signal based on speech recognition techniques, and filter the extracted information based on a level of surveillance criticality of the type of sound and the common spoken word in order to prioritize the extracted information that is visualized. In further embodiments, the processor may be further configured to perform or control performance of: receive, from the communication interface, another audio signal captured by another audio capture device, in response to a determination that the other audio signal is matched to a same corresponding video signal as the audio signal, determine the direction of sound in the audio signal based on a location of the audio capture device in relation to a location of the other audio capture device, and in response to a determination that the other audio signal is matched to a different corresponding video signal than the audio signal, one or more of: correlate a type of sound within the audio signal captured by the audio capture device at a first time with a type of sound within the other audio signal captured by the other audio capture device at a second time to determine the direction of sound in the audio signal, or compare a level of sound of the audio signal captured by the audio capture device at the first time with a level of sound of the other audio signal captured by the other audio capture device at the first time to determine the direction of sound in the audio signal.

According to further embodiments, the processor may be further configured to perform or control performance of: determine a resource to be deployed within a space that includes the audio capture device and the image capture device based on one or more of the type of sound in the audio signal, the common spoken word in the audio signal, the level of sound in the audio signal, or a change in the level of sound in the audio signal. In other embodiments, the audio capture device and the image capture device may be components integrated within a single capture device, or the audio capture device and the image capture device may be two separate capture devices. In further embodiments, the audio capture device may be located in a same space as the image capture device and may be one of: a component integrated with a communication device, a component integrated with a mobile device, or a single capture device.

According to other examples, a system may be configured to visualize an audio signal for a surveillance. The system may comprise an audio capture device, an image capture device, a display device, a server, and/or a communication interface. The communication interface may be configured to facilitate communication between the audio capture device, the image capture device, the display device, and the server. The audio capture device may be configured to capture the audio signal, and the image capture device may be configured to capture one or more video signals. The server may comprise a processor configured to receive, from the communication interface, the audio signal from the audio capture device, receive, from the communication interface, the one or more video signals from the image capture device, and analyze the audio signal to extract information associated with the surveillance. The processor may be further configured to perform or control performance of: match the audio signal to a corresponding video signal among the one or more video signals based on a spatial relationship between the audio capture device and the image capture device, overlay a visualization associated with the extracted information on the corresponding video signal, and provide the corresponding video signal with the overlaid visualization of the extracted information to the display device for display. The information associated with the surveillance may include one or more of a type of sound in the audio signal, a common spoken word in the audio signal, a direction of sound in the audio signal, and a level of sound in the audio signal.

In further examples, the audio capture device may include a microphone located in a same space as the image capture device, and the microphone may be integrated with the image capture device or may be a separate device from the image capture device. In other examples, the microphone may be integrated with a communication device or may be integrated with a mobile device, and the image capture device may include a camera. According to further examples, the processor may be configured to perform or control performance of: determine whether the audio capture device and the image capture device are integrated to determine the spatial relationship between the audio capture device and the image capture device, and in response to a determination that the audio capture device and the image capture device are not integrated, the processor may be further configured to perform or control performance of: determine a location of the audio capture device, determine an orientation of the image capture device, and match the audio signal to the corresponding video signal based on the location of the audio capture device and the orientation of the image capture device. In other examples, the processor may be further configured to perform or control performance of: determine the type of sound in the audio signal based on classification techniques; determine the common spoken word in the audio signal based on speech recognition techniques; and filter the extracted information based on a level of surveillance criticality of the type of sound and the common spoken word in order to prioritize the extracted information that is visualized.

According to further examples, wherein the processor may be further configured to perform or control performance of: receive, from the communication interface, another audio signal captured by another audio capture device; in response to a determination that the other audio signal is matched to a same corresponding video signal as the audio signal, determine the direction of sound in the audio signal based on a location of the audio capture device in relation to a location of the other audio capture device, and in response to a determination that the other audio signal is matched to a different corresponding video signal than the audio signal, one or more of: correlate a type of sound within the audio signal captured by the audio capture device at a first time with a type of sound within the other audio signal captured by the other audio capture device at a second time to determine the direction of sound in the audio signal or compare a level of sound of the audio signal captured by the audio capture device at the first time with a level of sound of the other audio signal captured by the other audio capture device at the first time to determine the direction of sound in the audio signal. In other examples, the processor may be further configured to perform or control performance of: determine a resource to be deployed within a space that includes the audio capture device and the image capture device based on one or more of the type of sound in the audio signal, the common spoken word in the audio signal, the level of sound in the audio signal, or a change in the level of sound in the audio signal.

There are various vehicles by which processes and/or systems and/or other technologies described herein may be effected (e.g., hardware, software, and/or firmware), and the preferred vehicle will vary with the context in which the processes and/or systems and/or other technologies are deployed. For example, if an implementer determines that speed and accuracy are paramount, the implementer may opt for mainly hardware and/or firmware vehicle; if flexibility is paramount, the implementer may opt for mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via application specific integrated circuits (ASICs), field programmable gate arrays (FPGAs), digital signal processors (DSPs), or other integrated formats. However, some aspects of the embodiments disclosed herein, in whole or in part, may be equivalently implemented in integrated circuits, as one or more computer programs executing on one or more computers (e.g., as one or more programs executing on one or more computer systems), as one or more programs executing on one or more processors (e.g., as one or more programs executing on one or more microprocessors), as firmware, or as virtually any combination thereof, and that designing the circuitry and/or writing the code for the software and/or firmware are possible in light of this disclosure.

The present disclosure is not to be limited in terms of the particular embodiments described in this application, which are intended as illustrations of various aspects. Many modifications and variations can be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled. The terminology used herein is for the purpose of describing particular embodiments only, and is not intended to be limiting.

In addition, the mechanisms of the subject matter described herein are capable of being distributed as a program product in a variety of forms, and an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive (HDD), a compact disc (CD), a digital versatile disk (DVD), a digital tape, a computer memory, a solid state drive (SSD), etc.; and a transmission type medium such as a digital and/or an analog communication medium (e.g., a fiber optic cable, a waveguide, a wired communication link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. A data processing system may include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors.

A data processing system may be implemented utilizing any suitable commercially available components, such as those found in data computing/communication and/or network computing/communication systems. The herein described subject matter sometimes illustrates different components contained within, or connected with, different other components. Such depicted architectures are merely exemplary, and in fact, many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

For any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments are possible. The various aspects and embodiments disclosed herein are for purposes of illustration and are not intended to be limiting, with the true scope and spirit being indicated by the following claims.

1. A method to visualize an audio signal for a surveillance, the method comprising:
receiving the audio signal captured by an audio capture device;
receiving one or more video signals captured by an image capture device;
analyzing the audio signal to extract information associated with the surveillance by determining one or more of a type of sound in the audio signal and a common spoken word in the audio signal;
selecting, among the one or more video signals, a video signal corresponding to the audio signal based on the analysis of the audio signal; and
overlaying a visualization associated with the extracted information on the corresponding video signal.

2. The method of claim 1, further comprising:
providing the corresponding video signal with the overlaid visualization of the extracted information to a display device for display.

3. (canceled)

4. The method of claim 1, wherein analyzing the audio signal to extract the information associated with the surveillance further comprises:
determining one or more of a direction of sound in the audio signal and a level of sound in the audio signal as the information associated with the surveillance.

5.-6. (canceled)

7. The method of claim 1, further comprising:
filtering the extracted information based on a level of surveillance criticality of one or more of the type of sound or the common spoken word in order to prioritize the extracted information that is visualized.

8. (canceled)

9. The method of claim 4, wherein determining the direction of sound in the audio signal comprises:
receiving another audio signal captured by another audio capture device, wherein the other audio signal includes a same sound as the audio signal;
matching the other audio signal to a different corresponding video signal than the audio signal; and
one or more of:
correlating a type of sound within the audio signal captured by the audio capture device at a first time with a type of sound within the other audio signal captured by the other audio capture device at a second time to determine the direction of sound; or
comparing a level of sound of the audio signal captured by the audio capture device at the first time with a level of sound of the other audio signal captured by the other audio capture device at the first time to determine the direction of sound.

10. The method of claim 4, further comprising:
determining a resource to be deployed within a space that includes the audio capture device and the image capture device based on one or more of the type of sound in the audio signal, the common spoken word in the audio signal, the level of sound in the audio signal, or a change in the level of sound in the audio signal.

11. (canceled)

12. The method of claim 1, wherein selecting, among the one or more video signals, a video signal corresponding to the audio signal comprises:
determining a spatial relationship between the audio capture device and the image capture device:
determining whether the audio capture device and the image capture device are integrated; and
in response to a determination that the audio capture device and the image capture device are not integrated:
determining a location of the audio capture device;
determining an orientation of the image capture device; and
matching the audio signal to the corresponding video signal based on the location of the audio capture device and the orientation of the image capture device.

13.-15. (canceled)

16. A computing device configured to visualize an audio signal for a surveillance, the computing device comprising:
a communication interface configured to facilitate communication between an audio capture device, an image capture device, and the server; and
a processor coupled to the communication interface, wherein the processor is configured to perform or control performance of:
receive, from the communication interface, the audio signal captured by the audio capture device;
receive, from the communication interface, one or more video signals captured by the image capture device;
analyze the audio signal to extract information associated with the surveillance, wherein the information associated with the surveillance includes one or more of a type of sound in the audio signal and a common spoken word in the audio signal;
select, among the one or more video signals, a video signal corresponding to the audio signal based on a spatial relationship between the audio capture device and the image capture device; and
overlay a visualization associated with the extracted information on the corresponding video signal.

17. The computing device of claim 16, wherein the communication interface is further configured to facilitate communication between the computing device and a display device to provide the corresponding video signal with the overlaid visualization of the extracted information to the display device for display.

18.-19. (canceled)

20. The computing device of claim 16, wherein the processor is configured to perform or control performance of:
determine whether the audio capture device and the image capture device are integrated to determine the spatial relationship between the audio capture device and the image capture device; and
in response to a determination that the audio capture device and the image capture device are not integrated:
determine a location of the audio capture device;
determine an orientation of the image capture device; and
match the audio signal to the corresponding video signal based on the location of the audio capture device and the orientation of the image capture device.

21. (canceled)

22. The computing device of claim 16, wherein the processor is further configured to perform or control performance of:
determine the type of sound in the audio signal based on classification techniques;
determine the common spoken word in the audio signal based on speech recognition techniques; and
filter the extracted information based on a level of surveillance criticality of the type of sound and the common spoken word in order to prioritize the extracted information that is visualized.

23. (canceled)

24. The computing device of claim 16, wherein the processor is further configured to perform or control performance of:
determine a resource to be deployed within a space that includes the audio capture device and the image capture device based on one or more of the type of sound in the audio signal, the common spoken word in the audio signal, the level of sound in the audio signal, or a change in the level of sound in the audio signal.

25.-27. (canceled)

28. A system configured to visualize an audio signal for a surveillance, the system comprising:
an audio capture device configured to capture the audio signal;
an image capture device configured to capture one or more video signals;
a display device; and
a server communicatively coupled to the audio capture device, the image capture device, the display device, the server comprising:
a communication interface configured to facilitate communication between the audio capture device, the image capture device, the display device, and the server; and
a processor configured to perform or control performance of:
receive, from the communication interface, the audio signal from the audio capture device;
receive, from the communication interface, the one or more video signals from the image capture device;
analyze the audio signal to extract information associated with the surveillance, wherein the information associated with the surveillance includes one or more of a type of sound in the audio signal and a common spoken word in the audio signal;
select, among the one or more video signals, a video signal corresponding to the audio signal based on a spatial relationship between the audio capture device and the image capture device;
overlay a visualization associated with the extracted information on the corresponding video signal; and
provide the corresponding video signal with the overlaid visualization of the extracted information to the display device for display.

29. The system of claim 28, wherein the audio capture device includes a microphone located in a same space as the image capture device.

30. The system of claim 29, wherein the microphone is integrated with the image capture device or a separate device from the image capture device.

31. (canceled)

32. The system of claim 29, wherein the microphone is integrated with a communication device or a mobile device.

33.-36. (canceled)

37. The system of claim 28, wherein the processor is configured to perform or control performance of:
determine whether the audio capture device and the image capture device are integrated to determine the spatial relationship between the audio capture device and the image capture device: and
in response to a determination that the audio capture device and the image capture device are not integrated:
determine a location of the audio capture device;
determine an orientation of the image capture device; and
match the audio signal to the corresponding video signal based on the location of the audio capture device and the orientation of the image capture device.

38. (canceled)

39. The system of claim 28, wherein the processor is further configured to perform or control performance of:
determine the type of sound in the audio signal based on classification techniques;
determine the common spoken word in the audio signal based on speech recognition techniques; and
filter the extracted information based on a level of surveillance criticality of the type of sound and the common spoken word in order to prioritize the extracted information that is visualized.

40. The system of claim 28, wherein the processor is further configured to perform or control performance of:
receive, from the communication interface, another audio signal captured by another audio capture device, wherein the other audio signal includes a same sound as the audio signal;
in response to a determination that the other audio signal is matched to a same corresponding video signal as the audio signal, determine the direction of sound in the audio signal based on a location of the audio capture device in relation to a location of the other audio capture device; and
in response to a determination that the other audio signal is matched to a different corresponding video signal than the audio signal, one or more of:
correlate a type of sound within the audio signal captured by the audio capture device at a first time with a type of sound within the other audio signal captured by the other audio capture device at a second time to determine the direction of sound in the audio signal; or
compare a level of sound of the audio signal captured by the audio capture device at the first time with a level of sound of the other audio signal captured by the other audio capture device at the first time to determine the direction of sound in the audio signal.

41. The system of claim 28, wherein the processor is further configured to perform or control performance of:
determine a resource to be deployed within a space that includes the audio capture device and the image capture device based on one or more of the type of sound in the audio signal, the common spoken word in the audio signal, the level of sound in the audio signal, or a change in the level of sound in the audio signal.
